(19) United States
(12) Patent Application Publication
(10) Pub. No.: US 2013/0091865 A1
(43) Pub. Date: Apr. 18, 2013

(54) EXHAUST GAS DIFFUSER

(71) Applicants: Deepesh Dinesh Nanda, Bangalore (IN); Joshy John, Bangalore (IN)

(72) Inventors: Deepesh Dinesh Nanda, Bangalore (IN); Joshy John, Bangalore (IN)

(73) Assignee: GENERAL ELECTRIC COMPANY, Schenectady, NY (US)

(21) Appl. No.: 13/275,040

(22) Filed: Oct. 17, 2011

(51) Int. Cl. F02C 3/04; F01D 25/30

(52) U.S. Cl. 60/805; 60/697

(57) ABSTRACT

An exhaust gas diffuser is provided and includes a peripheral body, a center body, formed to define an interior and disposed within the peripheral body to define an annulus between the peripheral body and the center body through which a first fluid flows along a main flow direction, a plurality of first members, each of which is respectively coupled to the peripheral body and the center body, to support the center body within the peripheral body and a plurality of second members, each of which extends across the annulus from the peripheral body to the center body downstream from the plurality of the first members relative to the main flow direction, to transport a second fluid to the center body interior. The plurality of the second members is circumferentially clocked relative to the plurality of the first members.

### BACKGROUND OF THE INVENTION

The subject matter disclosed herein relates to a turbomachine and, more particularly, to a turbomachine including an exhaust gas diffuser.

A primary source of loss and turbulence generation in an exhaust gas diffuser of a turbomachine, such as a gas engine turbine, is a result of flow interaction with struts and manways disposed within the flow through the exhaust gas diffuser. Struts and manways are typically aligned one behind other with the assumption being that the flow will see less of the manway blockage due to the strut blockage. It has been observed, however, that this assumption may be incorrect.

Indeed, with this setup, as the flow leaves the trailing edge of each of the struts, the wake generated by the trailing edge of each of the struts is a low momentum, weak flow that hits each of the manways and continues to diffuse further. Since the manways typically have relatively large diameters, the manways tend to generate a substantially larger wake. This substantially larger wake tends to reduce the diffuser effective area and thereby tends to reduce overall performance and diffuser life.

### BRIEF DESCRIPTION OF THE INVENTION

According to one aspect of the invention, an exhaust gas diffuser is provided and includes a peripheral body, a center body, formed to define an interior and disposed within the peripheral body to define an annulus between the peripheral body and the center body through which a first fluid flows along a main flow direction, a plurality of first members, each of which is respectively coupled to the peripheral body and the center body, to support the center body within the peripheral body and a plurality of second members, each of which extends across the annulus from the peripheral body to the center body downstream from the plurality of the first members relative to the main flow direction, to transport a second fluid to the center body interior. The plurality of the second members is circumferentially clocked relative to the plurality of the first members.

According to another aspect of the invention, a turbomachine is provided and includes a compressor to compress inlet gas, a combustor, fluidly coupled to the compressor and thereby receptive of the compressed gas from the compressor, in which the compressed gas is mixed with fuel and combusted to produce high temperature fluids and a turbine section fluidly coupled to the combustor and thereby receptive of the high temperature fluids, which is configured to generate mechanical energy from the high temperature fluids and comprises an exhaust gas diffuser. The exhaust gas diffuser includes a peripheral body, a center body, formed to define an interior and disposed within the peripheral body to define an annulus between the peripheral body and the center body through which a first fluid flows along a main flow direction, a plurality of first members, each of which is respectively coupled to the peripheral body and the center body, to support the center body within the peripheral body and a plurality of second members, each of which extends across the annulus from the peripheral body to the center body downstream from the plurality of the first members relative to the main flow direction, to transport a second fluid to the center body interior. The plurality of the second members is circumferentially clocked relative to the plurality of the first members.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a turbomachine;

FIG. 2 is a side view of an exhaust gas diffuser of the turbomachine of FIG. 1;

FIG. 3 is an axial view of the exhaust gas diffuser of FIG. 2;

FIG. 4 is a side view of components of the exhaust gas diffuser of FIG. 2 in accordance with an embodiment;

FIG. 5 is a side view of components of the exhaust gas diffuser of FIG. 2 in accordance with an alternative embodiment;

FIG. 6 is a radial view of a component of the exhaust gas diffuser of FIG. 2 in accordance with an embodiment;

FIG. 7 is a radial view of a component of the exhaust gas diffuser of FIG. 2 in accordance with an alternative embodiment;

FIG. 8 is a radial view of a component of the exhaust gas diffuser of FIG. 2 in accordance with an alternative embodiment;

FIG. 9 is a side view of an exhaust gas diffuser of the turbomachine of FIG. 1 in accordance with a further embodiment; and

FIG. 10 is a side view of an exhaust gas diffuser of the turbomachine of FIG. 1 in accordance with another further embodiment.

The detailed description explains embodiments of the invention, together with advantages and features, by way of example with reference to the drawings.

### DETAILED DESCRIPTION OF THE INVENTION

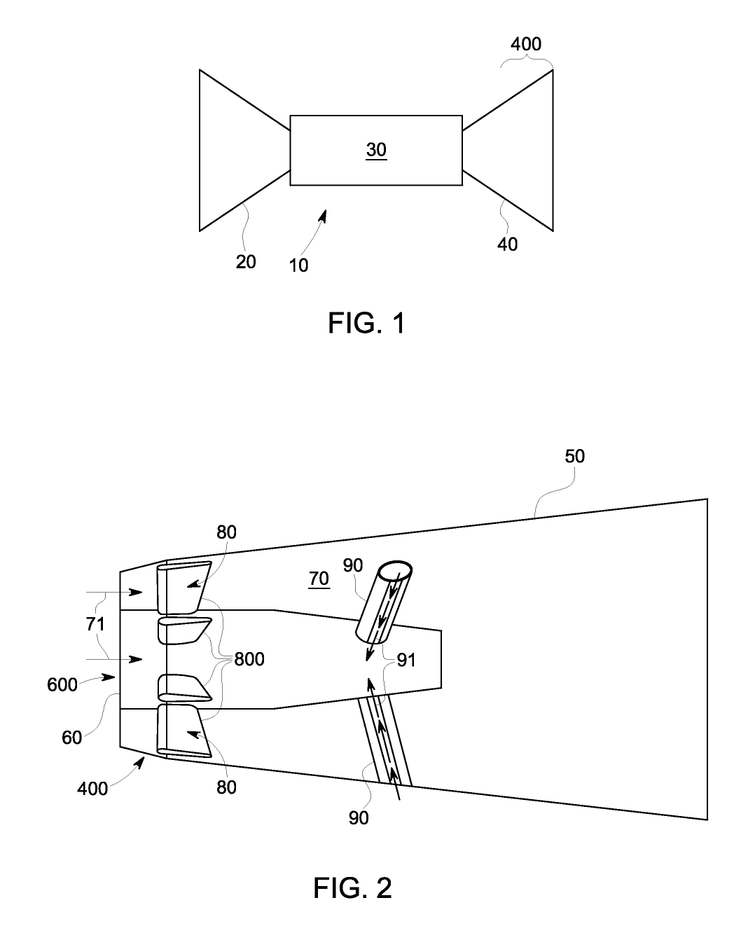

With reference to FIGS. 1 and 2, a turbomachine 10, such as a gas turbine engine, is provided. The turbomachine 10 includes a compressor 20, which is configured to compress inlet gas, a combustor 30 and a turbine section 40. The combustor 30 is fluidly coupled to the compressor 20 and thereby receptive of the compressed gas from the compressor 20. Within the combustor 30, the compressed gas is mixed with fuel and combusted to produce high temperature fluids. The turbine section 40 is fluidly coupled to the combustor 30 and is configured to thereby receive the high temperature fluids produced in the combustor 30. The turbine section 40 is configured to generate mechanical energy from the received high temperature fluids produced by the combustion and includes an exhaust gas diffuser 400.

As shown in FIG. 2, the exhaust gas diffuser 400 includes a peripheral body 50, which may be annular and/or divergent in shape, and a center body 60. The center body 60 may also be annular in shape and is formed to define an interior 600 therein. The center body 60 is disposed within the peripheral body 50 to define an annulus 70 between an interior surface of the peripheral body 50 and an exterior surface of the center body 60. This annulus 70 is formed to define a pathway along which a first fluid 71 may be directed to flow along a main flow direction. The exhaust gas diffuser 400 further includes a plurality of first members 80 and a plurality of second members 90.

The plurality of the first members 80 are provided as, for example, struts extending from the peripheral body 50 to the center body 60. The plurality of the first members 80 are each respectively coupled to the peripheral body 50 and to the center body 60 to support the center body 60 within the peripheral body 50. The plurality of the first members 80 may be arranged in a circumferential array about the center body 60, with each first member 80 being angularly distant from adjacent first members 80 at uniform and/or non-uniform angular distances.

The plurality of the second members 90 are provided as, for example, manways extending from the peripheral body 50 to the center body 60. The plurality of the second members 90 are each configured to extend across the annulus 70 from the peripheral body 50 to the center body 60 and may be disposed at respective axial locations that are downstream from the plurality of the first members 80 relative to the flow of the first fluid 71 along the main flow direction. The plurality of the second members 90 may be configured to transport a second fluid 91 from an exterior of the peripheral body 50 to the interior 600 of the center body 60.

In accordance with further embodiments, the plurality of the second members 90 may also be coupled to the peripheral body 50 and to center body 60 to support the center body 60 within the peripheral body 50. The plurality of the second members 90 may also be arranged in a circumferential array about the center body 60, with each second member 90 being angularly distant from adjacent second members 90 at uniform and/or non-uniform angular distances.

With reference to FIGS. 2-5, each one of the plurality of the first members 80 includes a trailing edge 800 that generates a wake due to interference thereof with the flow of the first fluid 71. This wake is a low momentum, weak flow that continuously diffuses along a length of the exhaust gas diffuser 400 toward the plurality of the second members 90. Since each of the plurality of the second members 90 is normally relatively wide as compared to the first members 80, interactions between the wake and the plurality of the second members 90 can lead to wakes generated by the plurality of the second members 90 of significantly increased size that lead to further disturbances in the flow of the first fluid 71.

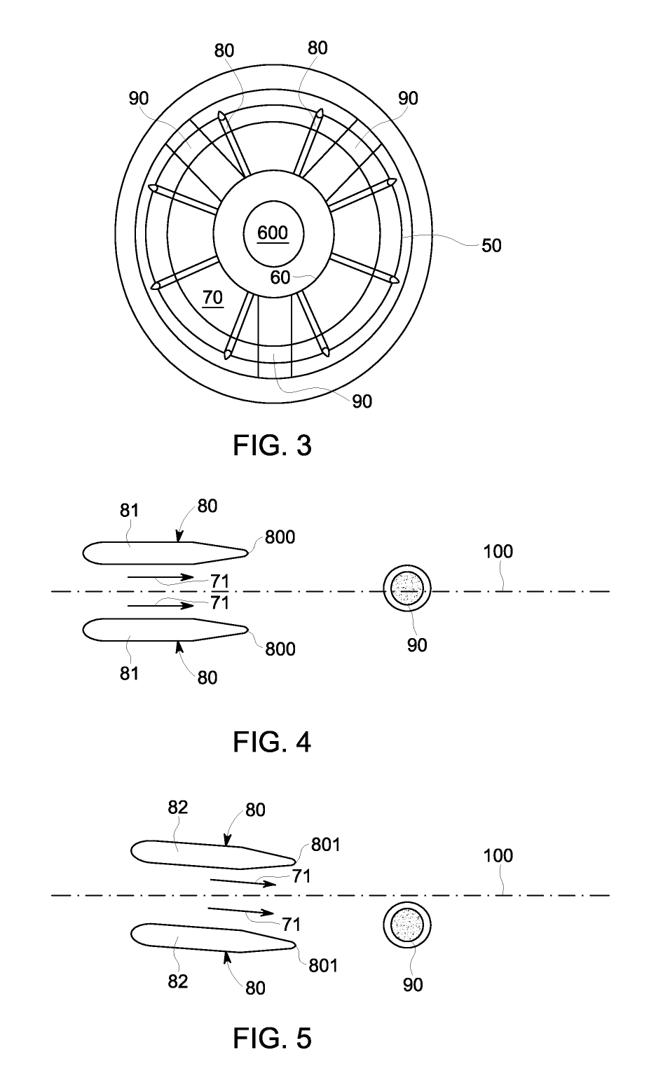

As shown in FIG. 3, the plurality of the second members 90 may be circumferentially clocked relative to the plurality of the first members 80 such that the wake generated by the respective trailing edges 800 of the first members 80 can be directed to avoid hitting the plurality of the second members 90 at least in part. In accordance with an exemplary embodiment, the plurality of the first members 80 may be provided as eight (8) first members 80 with substantially uniform angular distance between adjacent first members 80 while the plurality of the second members 90 may be provided as three (3) second members 90. Of these three second members 90, each one is circumferentially clocked at about a circumferential midway (or 50%) between adjacent first members 80 with an angular tolerance of about ±5 degrees. As such, the wake generated by the trailing edges 800 will tend to avoid hitting the plurality of the second members 90 at least in part. The plurality of the second members 90 will therefore see high momentum, strong flow and will, therefore, tend to generate relatively smaller wakes then they otherwise would. This may aid in overall flow mixing and improved performance of the exhaust gas diffuser 400.

Although the pluralities of the first and second members 80 and 90 are described above as having eight first members 80 and three second members 90, it is to be understood that this configuration is merely exemplary and that more or less first members 80 or second members 90 may be provided. In any case, the circumferential clocking of the second members 90 may be maintained to the degree made possible by the numbers of the first and second members 80 and 90.

With reference to FIGS. 4 and 5, each of the plurality of the first members 80 may include symmetrically disposed struts 81 that direct the flow of the first fluid 71 downstream in alignment with a centerline 100 of the turbomachine 10 (see FIG. 4). Alternatively, each of the plurality of the first members 80 may include cambered struts 82 that direct the flow of the first fluid 71 downstream at an angle relative to the centerline 100. In either case, the circumferential clocking of the corresponding one of the plurality of the second members 90 may be adjusted such that the second member 90 is circumferentially clocked at about a circumferential midway (or 50%) between adjacent first members 80 with an angular tolerance of about ±5 degrees.

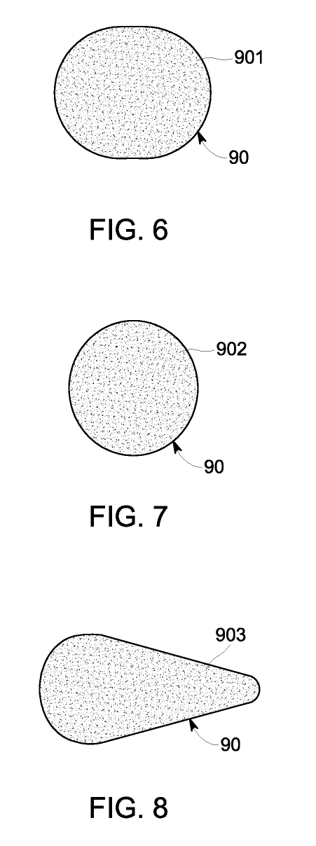

With reference to FIGS. 6-8, each one or more of the plurality of the second members 90 may have an oval-shaped cross-section 901 (see FIG. 6), a circular cross-section 902 (see FIG. 7) or an airfoil-shaped cross-section 903 (see FIG. 8). Each one of the various shapes of the plurality of the second members 90 may be provided to each of the second members 90 or in combination with one or more of the other various shapes. Also, where the plurality of the first members 80 is symmetric, the plurality of the second members 90 may be symmetric or cambered. Similarly, where the plurality of the first members 80 is cambered, the plurality of the second members 90 may be symmetric or cambered.

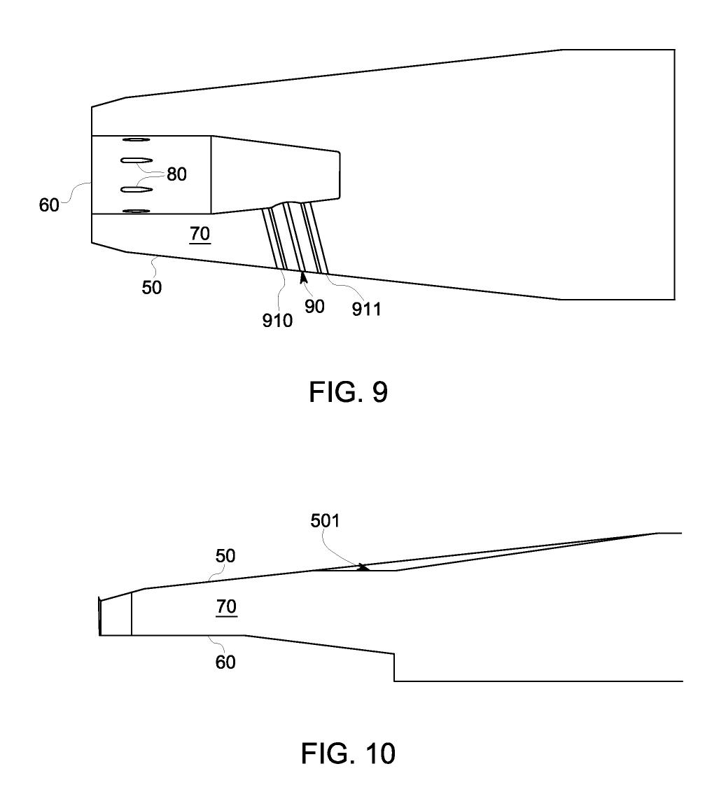

With reference to FIG. 9, each one of the plurality of the second members 90 may include at least one or both of an upstream vortex breaker 910 and a downstream vortex breaker 911. The upstream and downstream vortex breakers 910 and 911 are disposed forward and aft of the one of the second members 90 to which they are associated, respectively, may be circumferentially clocked in correspondence with the one of the second members 90 to which they are associated.

With reference to FIG. 10, the peripheral body 50 may be formed to include a Carnot section 501. The Carnot section 501 is characterized as a narrowing of the diffuser flow area from a first axial location to a second axial location downstream from the first axial location. The Carnot section 501 in this case may be substantially axially aligned with the plurality of the second members 90.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An exhaust gas diffuser, comprising:
a peripheral body;
a center body, formed to define an interior and disposed within the peripheral body to define an annulus between the peripheral body and the center body through which a first fluid flows along a main flow direction;
a plurality of first members, each of which is respectively coupled to the peripheral body and the center body, to support the center body within the peripheral body; and
a plurality of second members, each of which extends across the annulus from the peripheral body to the center body downstream from the plurality of the first members relative to the main flow direction, to transport a second fluid to the center body interior,
the plurality of the second members being circumferentially clocked relative to the plurality of the first members.

2. The exhaust gas diffuser according to claim 1, wherein the plurality of the first members comprises 8 first members arrayed substantially uniformly about the center body, and the plurality of the second members comprises 3 second members arrayed non-uniformly about the center body.

3. The exhaust gas diffuser according to claim 1, wherein each of the plurality of the second members is disposed circumferentially midway between an adjacent pair of the plurality of the first members.

4. The exhaust gas diffuser according to claim 1, wherein each of the plurality of the first members comprises a symmetric strut.

5. The exhaust gas diffuser according to claim 1, wherein each of the plurality of the first members comprises a cambered strut.

6. The exhaust gas diffuser according to claim 1, wherein each of the plurality of the second members has an oval-shaped cross-section.

7. The exhaust gas diffuser according to claim 1, wherein each of the plurality of the second members has a circular cross-section.

8. The exhaust gas diffuser according to claim 1, wherein each of the plurality of the second members has an airfoil-shaped cross-section.

9. The exhaust gas diffuser according to claim 1, wherein each of the plurality of the second members comprises at least one or both of an upstream vortex breaker and a downstream vortex breaker.

10. The exhaust gas diffuser according to claim 1, wherein the peripheral body comprises a Carnot section substantially axially aligned with the plurality of the second members.

11. A turbomachine, comprising:
a compressor to compress inlet gas;
a combustor, fluidly coupled to the compressor and thereby receptive of the compressed gas from the compressor, in which the compressed gas is mixed with fuel and combusted to produce high temperature fluids; and
a turbine section fluidly coupled to the combustor and thereby receptive of the high temperature fluids, which is configured to generate mechanical energy from the high temperature fluids and comprises an exhaust gas diffuser, the exhaust gas diffuser comprising:
a peripheral body;
a center body, formed to define an interior and disposed within the peripheral body to define an annulus between the peripheral body and the center body through which a first fluid flows along a main flow direction;
a plurality of first members, each of which is respectively coupled to the peripheral body and the center body, to support the center body within the peripheral body; and
a plurality of second members, each of which extends across the annulus from the peripheral body to the center body downstream from the plurality of the first members relative to the main flow direction, to transport a second fluid to the center body interior,
the plurality of the second members being circumferentially clocked relative to the plurality of the first members.

12. The turbomachine according to claim 11, wherein the plurality of the first members comprises 8 first members arrayed substantially uniformly about the center body, and the plurality of the second members comprises 3 second members arrayed non-uniformly about the center body.

13. The turbomachine according to claim 11, wherein each of the plurality of the second members is disposed circumferentially midway between an adjacent pair of the plurality of the first members.

14. The turbomachine according to claim 11, wherein each of the plurality of the first members comprises a symmetric strut.

15. The turbomachine according to claim 11, wherein each of the plurality of the first members comprises a cambered strut.

16. The turbomachine according to claim 11, wherein each of the plurality of the second members has an oval-shaped cross-section.

17. The turbomachine according to claim 11, wherein each of the plurality of the second members has a circular cross-section.

18. The turbomachine according to claim 11, wherein each of the plurality of the second members has an airfoil-shaped cross-section.

19. The turbomachine according to claim 11, wherein each of the plurality of the second members comprises at least one or both of an upstream vortex breaker and a downstream vortex breaker.

20. The turbomachine according to claim 11, wherein the peripheral body comprises a Carnot section substantially axially aligned with the plurality of the second members.
